(19) United States
(12) Patent Application Publication
(10) Pub. No.: US 2013/0134321 A1
(43) Pub. Date: May 30, 2013

(54) DETECTOR FOR ENERGETIC SECONDARY ELECTRONS

(71) Applicants: Frank Torregrosa, Simiane (FR); Laurent Roux, Marseille (FR)

(72) Inventors: Frank Torregrosa, Simiane (FR); Laurent Roux, Marseille (FR)

(73) Assignee: ION BEAM SERVICES, Peynier (FR)

(21) Appl. No.: 13/701,264

(22) PCT Filed: Jun. 1, 2011
(86) PCT No.: PCT/FR11/00324

§ 371 Date: Feb. 15, 2013

(30) Foreign Application Priority Data
Jun. 3, 2010 (FR) 1002354

(51) Int. Cl. G01T 1/28

(52) U.S. Cl. CPC G01T 1/28
USPC 250/395; 250/336.1

(57) ABSTRACT

The present invention relates to a high-energy secondary electron detector comprising a collector P supporting only three electrodes that are insulated from one another and that are biased relative to the collector:
a first repulsion electrode A1 for repelling charges of a first predetermined sign that are to be repelled, this negatively-biased electrode being provided with at least one opening for passing electrons;
a second repulsion electrode A2 for repelling charges of the opposite sign that are to be repelled, this positively-biased electrode also being provided with at least one opening for passing electrons; and
a selection electrode A3, this electrode also being provided with at least one opening for passing electrons;
the openings in said electrodes being in alignment along a conduction cylinder D.
   Furthermore, the selection electrode A3 is negatively biased.

The invention also provides a method of detecting secondary electrons by means of the detector.

The present invention relates to a detector of high-energy secondary electrons.

The field of the invention is thus that of analyzing secondary electrons in a plasma.

A particularly advantageous application of the invention lies in ion implanters operating in plasma immersion mode.

Thus, implanting ions in a substrate consists in immersing the substrate in a plasma and in biasing it with a negative voltage of a few tens of volts to a few tens of kilovolts (generally less than 100 kV), so as to create an electric field capable of accelerating the ions of the plasma towards the substrate so that they become implanted therein. The atoms that are implanted in this way are referred to as “dopants”.

The penetration depth of the ions is determined by their acceleration energy. It depends firstly on the voltage applied to the substrate and secondly on the respective natures of the ions and of the substrate. The concentration of implanted atoms depends on the dose which is expressed as a number of ions per square centimeter (ions/cm²) and on the implantation depth.

Nevertheless, one of the consequences of implantation is that secondary electrons are produced at the substrate. These secondary electrons are accelerated (in the opposite direction to the positive ions) by the potential applied to the substrate, and they are therefore referred to as high-energy secondary electrons.

One of the essential parameters during implantation is the dose of dopants that have been implanted. This dose needs to be known accurately.

One known means for estimating the implantation dose consists in measuring the implantation current Ip at the substrate. Nevertheless, the implantation current Ip is found to be the sum of the ion current I₊ and of the high-energy secondary electron current I₋.

Thus, to obtain the implanted dose by interacting the ion current I₊ over time, it is appropriate to subtract the secondary electron current I₋ from the implantation current Ip.

Several solutions are known for detecting charged species within a plasma.

Document WO 93/12534 teaches an energy analysis device for measuring the energies of charged particles. That device comprises a collector surmounted by a first grid, itself surmounted by a second grid, all of those electrically-conductive elements being insulated. If negative species are to be detected, the second grid is given a negative bias in order to repel low-energy negative species, and the first grid is biased in order to repel positive species. The essential limitation of that device comes from the fact that the high-energy secondary electrons themselves produce low-energy secondary electrons when they strike the collector. Some of those low-energy electrons are picked up by the first grid since it is positively biased. The estimate of the high-energy secondary electron current is thus highly distorted.

Also known is the document “Comparison of plasma parameters determined with a Langmuir probe and with a retarding field energy analyzer; RFEA and Langmuir probe comparison” by D. Gahan, et al., published in Plasma Sources Science and Technology, Institute of Physics Publishing, Bristol, GB, Vol. 17, No. 3, Aug. 1, 2008, pp. 035026-1 to 035026-9. That document also discloses an RFEA detector comprising two electrodes and also having a top grid that acts solely to extract ionized species from the plasma.

Other charged species detectors are also known that have four grids, five grids, or even more. This applies for example to the document “Retarding field energy analyzer for the Saskatchewan torus-modified plasma boundary” by M. Dreval et al., published in Review of Scientific Instruments, AIP, Melville, N.Y., US, Vol. 80, No. 10, Oct. 22, 2009, pp. 103505-1 to 103505-9. The analyzer described has a collector with four electrodes arranged facing it, the fourth electrode being an inlet slot.

Those are structures that are mechanically complex and that require associated electronics that is likewise complex.

Also known is the article “A retarding field energy analyzer for the Jet plasma boundary” published in Review of Scientific Instruments 74, 4644 (2003); doi: 10.1063/1.1619554.

That article proposes a detector known as a retarding field analyzer (RFA). That detector comprises a collector surmounted by a first grid, itself surmounted by a second grid, itself surmounted by a selection electrode. The selection electrode is in the form of a diaphragm that presents an opening of area that is very small since its size is of the same order of magnitude as the Debye length. It follows that if that detector is used in an ion implanter, it will detect only a tiny fraction of the high-energy secondary electrons.

It should also be observed that the bias voltages that are applied are incompatible with plasma immersion mode implantation since they are too great. They would disturb the plasma.

Finally, document US 2009/242791 is known, which describes an energy analyzer for ions. That analyzer comprises a collector having only three electrodes that are mutually insulated from one another:

a first repulsion electrode for repelling charges of a first predetermined sign that are to be repelled, that electrode having at least one opening;

a second repulsion electrode for repelling charges of the opposite sign that are to be repelled, that electrode also being provided with at least one opening; and

a selection electrode, that electrode also being provided with at least one opening.

That is indeed an ion detector that is not suitable for detecting secondary electrons.

An object of the present invention is thus to provide a high-energy secondary electron detector that is effective and that is mechanically simple to implement.

According to the invention, a high-energy secondary electron comprises a high-energy secondary electron detector comprising a collector supporting only three electrodes that are insulated from one another and that are biased relative to the collector:

a first repulsion electrode for repelling charges of a first predetermined sign that are to be repelled, this negatively-biased electrode being provided with at least one opening for passing electrons;

a second repulsion electrode for repelling charges of the opposite sign that are to be repelled, this positively-biased electrode also being provided with at least one opening for passing electrons; and

a selection electrode, this electrode also being provided with at least one opening for passing electrons;

the openings in said electrodes being in alignment along a conduction cylinder;

furthermore, said selection electrode is negatively biased.

Also, said collector is in the form of a cup.

According to an additional characteristic of the invention, said electrodes are made of aluminum.

Preferably, the spacing between two consecutive electrodes lies in the range 6 millimeters (mm) to 10 mm.

Ideally, the openings in said electrodes present an area lying in the range 15 square millimeters (mm²) to 30 mm².

In a first embodiment, said electrodes are constituted by grids.

Advantageously, the transparency of said grids is greater than 50%.

It is also desirable, when the distance between two consecutive grids is written h and the diameter of the orifices in said grids is written D, for the ratio written h/D to be greater than 1.

The fact that the electrodes are grids, nevertheless leads to several limitations.

Firstly, the transparency of the grids is necessarily limited, thereby limiting the sensitivity of the detector.

Secondly, the grids are subjected to wear so that their orifices become larger. As a result, current measurements drift, since the electron-collection area increases as wear progresses. The wear also releases pollutants into the enclosure.

It is therefore appropriate to replace the grids periodically, and unfortunately they are components that are relatively expensive.

Thus, in a second embodiment, the electrodes are constituted by rings.

As above, and preferably, the distance between two consecutive rings is written h, the diameter of said conduction cylinder is written D, and the ratio written h/D is greater than 1.

The invention also provides a method of detecting secondary electrons by means of a detector comprising:

a collector for collecting the required charges and supporting only three electrodes that are insulated from one another;

a first electrode for repelling charges of a predetermined sign that are to be repelled;

a second electrode for repelling charges of the opposite sign that are to be repelled; and

a selection electrode;

the collector being taken as a reference and the method consisting in applying:

a negative first DC voltage to the first electrode at an absolute value of less than 120 volts;

a positive second DC voltage to the second electrode; and

a negative third DC voltage which is applied to said selection electrode.

By way of example, the second voltage has an absolute value of less than 120 volts.

Similarly, the third voltage has an absolute value of less than 60 volts.

The present invention appears in greater detail below in the context of the following description of an embodiment given by way of illustration and with reference to the accompanying Figures, in which:

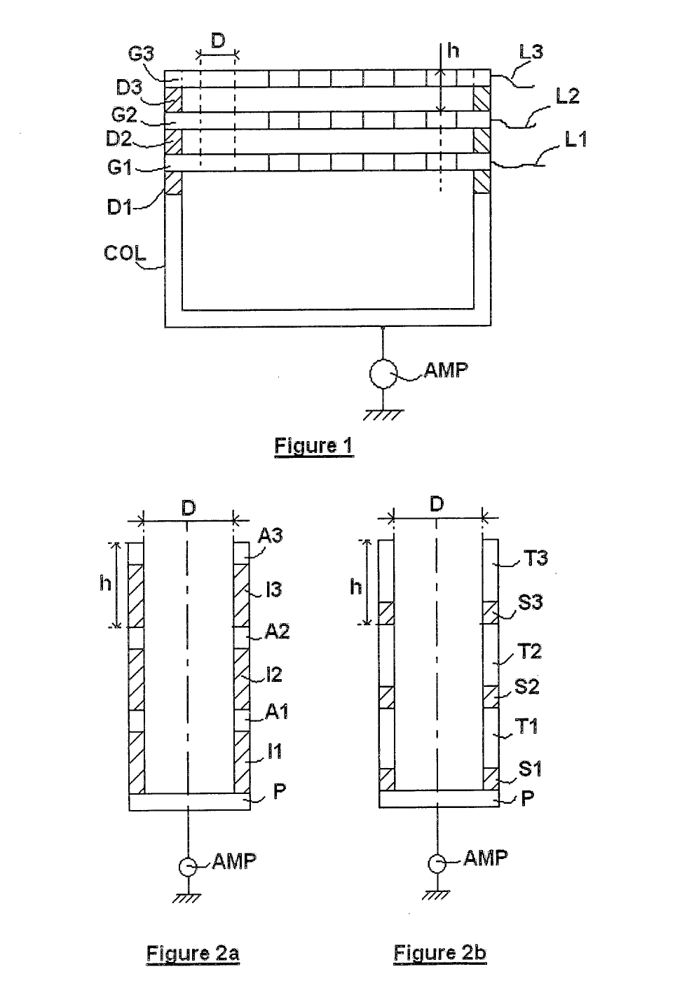

FIG. 1 is a diagrammatic section view of a first embodiment of a detector of the invention; and

FIG. 2 is a diagrammatic section view of a second embodiment of a detector, and more particularly:

FIG. 2a shows a first variant of the second embodiment; and

FIG. 2b shows a second variant of the second embodiment.

Elements present in more than one of the figures are given the same references in each of them.

With reference to FIG. 1, in a first embodiment, the detector comprises a collector COL in the form of a cup or a bell. The collector COL is connected to ground via an ammeter AMP that measures the secondary electron current.

The collector COL is surmounted by a first insulator D1, itself surmounted by a first electrically-conductive grid G1.

The first grid G1 is surmounted by a second insulator D2, itself surmounted by a second electrically-conductive grid G2.

The second grid G2 is surmounted by a third insulator D3, itself surmounted by a third electrically-conductive grid G3.

The spacing between the grids G1-G2 and G2-G3 preferably lies in the range 6 mm to 10 mm. It is typically 8 mm.

It is recalled that transparency is defined as the ratio of the area of the openings in the grid to the total area of the grid. In the present example, the transparency of the grid must be very high, preferably greater than 50%.

These openings must also present area that is relatively large so that they do not capture the charged species that need to reach the collector. Advantageously, this area lies in the range 15 mm² to 30 mm². By way of example, a circular opening may present a diameter of the order of 5 mm.

The detector needs to fulfill the following functions:

recover the high-energy secondary electrons on the collector COL;

recover the low-energy secondary electrons on the collector when they are the result of impacts of the high-energy electrons; and

repel the low-energy electrons and ions of the plasma.

It is also appropriate to avoid creating a plasma or an arc within the detector as a result of the bias voltages applied to the grids G1, G2, and G3. For this purpose, reference may be made to Paschen's law. The detector must not add species that would contaminate the plasma. For applications in the field of microelectronics, it is advantageous to select aluminum for the conductors and alumina for the insulators.

It is also necessary to avoid disturbing the plasma generated within the ion implanter.

The first grid G1 is biased by means of a first cable L1 to a negative voltage of less than 120 volts, typically 100 volts, relative to the collector COL.

The second grid G2 is biased by means of a second cable L2 to a positive voltage of less than 120 volts, typically 100 volts, relative to the collector COL.

The third grid G3 is biased by means of a third cable L3 to a negative voltage of less than 60 volts, typically 50 volts, relative to the collector COL.

In this first embodiment, the detector has a plurality of openings, each of these openings corresponding to three orifices in alignment through the grids.

Thus, these openings are each in alignment on a conduction cylinder of diameter D.

Writing the diameter of these openings as D and the distance between two grids as h, the ratio written h/D has a magnitude of about 1.5, and is in any event preferably greater than 1.

In a second embodiment, the detector no longer presents a plurality of openings but presents a tubular structure having a single opening.

With reference to FIG. 2a, in a first variant, the collector P is in the form of a tray. The collector is surmounted by a first insulating ring I1, which is itself surmounted by a first conductive ring A1. The inside diameter of these two rings is D. The thickness of the first insulating ring I1 is substantially greater than the thickness of the first conductive ring A1 and the sum of these two thicknesses is h.

The first conductive ring A1 is surmounted by a second insulating ring I2, itself surmounted by a second conductive ring A2.

These second rings I2 and A2 have the same shape as the first rings I1 and A1.

The second conductive ring A2 is surmounted by a third insulating ring I3, itself surmounted by a third conductive ring A3. These third rings I3 and A3 are likewise of the same shape as the first rings I1 and A1.

The collector P is likewise connected to ground via an ammeter AMP.

The shape is the same as the shape of the openings in the first embodiment. Thus, the ratio h/D is preferably greater than 1.

The first, second, and third conductive rings A1, A2, and A3 are biased like the first, second, and third grids G1, G2, and G3 respectively in the first embodiment.

With reference to FIG. 2b, in a second variant, the collector P is likewise in the form of a tray. The collector is surmounted by a first insulating ring S1 itself surmounted by a first conductive ring T1. The inside diameter of these two rings is once more D. In contrast, the thickness of the first insulating ring S1 is considerably smaller than the thickness of the first conductive ring T1, and the sum of these two thicknesses is still h.

The first conductive ring T1 is surmounted by a second insulating ring S2, itself surmounted by a second conductive ring T2.

These second rings S2, T2 have the same shape as the first rings S1, T1.

Likewise, the second conductive ring T2 is surmounted by a third insulating ring S3, itself surmounted by a third conductive ring T3. These third rings S3, T3 are likewise of the same shape as the first rings S1, T1.

Once more, the shape reproduces that of the openings in the first embodiment. Thus, the ratio h/D is preferably greater than 1.

In this second variant, the rings are analogous to the rings of the first variant, but the thicknesses of the insulating elements and the conductive elements are interchanged.

The above-described embodiment of the invention has been selected because of its concrete nature. Nevertheless, it is not possible to list exhaustively all embodiments covered by the invention. In particular, any of the means described may be replaced by equivalent means without going beyond the ambit of the present invention.

1. A high-energy secondary electron detector comprising a collector (COL, P) supporting only three electrodes that are insulated from one another and that are biased relative to the collector:
a first repulsion electrode (G1, A1, T1) for repelling charges of a first predetermined sign that are to be repelled, this negatively-biased electrode being provided with at least one opening for passing electrons;
a second repulsion electrode (G2, A2, T2) for repelling charges of the opposite sign that are to be repelled, this positively-biased electrode also being provided with at least one opening for passing electrons; and
a selection electrode (G3, A3, T3), this electrode also being provided with at least one opening for passing electrons;
the openings in said electrodes being in alignment along a conduction cylinder (D), and the detector being characterized in that said selection electrode (G3, A3, T3) is negatively biased.

2. A detector according to claim 1, characterized in that said collector (COL) is in the form of a cup.

3. A detector according to claim 1, characterized in that said electrodes (G1-A1-T1, G2-A2-T2, G3-A3-T3) are made of aluminum.

4. A detector according to claim 1, characterized in that the spacing between two consecutive electrodes (G1-G2, G2-G3) lies in the range 6 mm to 10 mm.

5. A detector according to claim 1, characterized in that the openings in said electrodes (G1-A1-T1, G2-A2-T2, G3-A3-T3) present an area lying in the range 15 mm² to 30 mm².

6. A detector according to claim 1, characterized in that said electrodes are constituted by grids (G1, G2, G3).

7. A detector according to claim 6, characterized in that the transparency of said grids (G1, G2, G3) is greater than 50%.

8. A detector according to claim 6, characterized in that the distance between two consecutive grids is written h, the diameter of the orifices in said grids is written D, and the ratio written h/D is greater than 1.

9. A detector according to claim 1, characterized in that said electrodes are constituted by rings (A1-T1, A2-T2, A3-T3).

10. A detector according to claim 9, characterized in that the distance between two consecutive rings is written h, the diameter of said conduction cylinder is written D, and the ratio written h/D is greater than 1.

11. A method of detecting secondary electrons by means of a detector comprising:
a collector (COL) for collecting the required charges and supporting only three electrodes that are insulated from one another;
a first electrode (G1, A1, T1) for repelling charges of a predetermined sign that are to be repelled;
a second electrode (G2, A2, T2) for repelling charges of the opposite sign that are to be repelled; and
a selection electrode (G3, A3, T3);
the method being characterized in that said collector (COL) is taken as a reference and the method consists in applying:
a negative first DC voltage to the first electrode (G1, A1, T1) at an absolute value of less than 120 volts;
a positive second DC voltage to the second electrode (G2, A2, T2); and
a negative third DC voltage which is applied to said selection electrode (G3, A3, T3).

12. A method according to claim 11, characterized in that said second voltage has an absolute value of less than 120 volts.

13. A method according to claim 11, characterized in that said third voltage has an absolute value of less than 60 volts.
